(19) United States
(12) Patent Application Publication
(10) Pub. No.: US 2014/0123597 A1
(43) Pub. Date: May 8, 2014

(54) CAPPING CHUCK

(71) Applicant: Raymond Mallett, Cronulla (NSW) (AU)

(72) Inventor: Raymond Mallett, Cronulla (NSW) (AU)

(21) Appl. No.: 14/118,394

(22) PCT Filed: May 18, 2012
(86) PCT No.: PCT/AU2012/000548

§ 371 Date: Jan. 23, 2014

(30) Foreign Application Priority Data
May 19, 2011 (AU) 2011 901 920

(51) Int. Cl. B67B 3/20

(52) U.S. Cl. CPC B67B 3/2066
USPC 53/317

(57) ABSTRACT

A non powered gripping chuck for closing closures onto a container comprising: a chuck body (16) adapted to be rotated wherein the chuck body (16) is circular and has a circumferential rim, pivoting chuck jaws (22) attached in a spaced apart manner to an annular region proximate the circumferential rim by way of pivot pins (24), where the spaced apart pivoting chuck jaws (22) define a capping zone into which a closure can be introduced. The pivoting chuck jaws have a knurls (32) that are distal to the pivot pin (24), where the knurls (32) come into contact with an introduced closure. Chuck also features biasing means (18) for biasing the chuck jaws against spacing means which maintain a minimum diameter for the closure to be inserted into. Wherein in operation when a closure is inserted into the capping zone, the contact portion are initially biased against the closure by the biasing means and where during rotation forces are exerted on the surface of the closure by the contact portion (32) of the pivoting chuck 36 causing the closure to be tightly gripped during the application of the closure.

### TECHNICAL FIELD

The invention involves the use of chucks in capping apparatus which are used to close threaded bottles.

### BACKGROUND ART

Capping chucks are utilised in capping machines that are installed into bottling lines and which operate by gripping the closure to be applied to the bottle and whilst it is being gripped, is turned to effect a seal.

Simple chucks of the prior art are made of a single piece and have no moving parts. The problem with these simple chucks is that the closures that they must be designed to work for, are not always consistent. Production/manufacturing variations, including variations in the diameter are often experienced between batches of closures. The diameter variation often represents more than the depth of the knurls (which are the tiny raised portions put onto a closure to provide the chuck a surface with which to grip onto). As a result, whatever size the chuck is made, it is often too loose and can't deliver the torque or it is too tight and the closure won't enter the chuck. This results in sometimes bottles coming off the line that look closed but in fact are not which is quite dangerous from a health and safety perspective. Also the closures may be cross threaded or missing, representing waste production. Also, simple, prior art capping chucks would often (on a statistical basis) receive closures in a way where the knurls of the closure would align with the knurls of the chuck, in a way that interferes with the application process.

The past solution was to use a more complicated, powered gripping chuck and an expensive machine that is designed to have a powered gripping chuck.

It is an object of the present invention to provide an improved non-powered gripping chuck for use in bottling lines that are configured to utilise only simple non-powered gripping chucks.

### DISCLOSURE OF INVENTION

In a first aspect and embodiment of the invention there is provided a non-powered gripping chuck for applying screwed closures comprising a plurality of pivoting jaws arranged in a circular arrangement and defining capping zone, the pivoting jaws being connected such that they have a pivot point and a contact portion that comes into contact with a closure introduced into the capping zone, wherein the contact portion is offset from the pivot point such that the pivoting jaws tightly grip against the closure on rotation of the chuck.

Preferably the contact portion trails the pivot point of each of the plurality of pivoting jaws, during rotation of the chuck. More preferably the vertical and horizontal measures of the offset between the contact portion and pivot points of the plurality of pivoting jaws, when expressed as a ratio, is greater than or equal to 0.25.

Alternatively in the case of the second embodiment of the invention, the contact portion leads the pivot point of the plurality of pivoting jaws, during rotation of the chuck.

Preferably the vertical and horizontal measures of the offset between the contact portion and pivot point of the plurality of pivoting jaws in this second embodiment of the invention, when expressed as a ratio, is greater than or equal to 1.2.

According to a second aspect of the invention there is provided a non powered gripping chuck for closing closures onto a container comprising:
chuck body adapted to be rotated wherein the chuck body is circular and has a circumferential rim;
pivoting chuck jaws attached in a spaced apart manner to an annular region proximate the circumferential rim by way of pivot pins, where the pivoting chuck jaws define a capping zone into which a closure can be introduced, and wherein the pivoting chuck jaws have a contact portion that is distal to the pivot pin that comes into contact with an introduced closure;
biasing means for biasing the chuck jaws against spacing means which maintain a minimum diameter for the closure to be inserted into, and wherein, in operation when a closure is inserted into the capping zone, the contact portion are initially biased against the closure by the biasing means and where during rotation forces are exerted on the surface of the closure by the contact portion of the pivoting chuck causing the closure to be tightly gripped during the application of the closure.

Preferably the contact portions trail the pivot pins.

Alternatively, in a second embodiment of the invention, the distal portions lead in advance of the pivot pins.

Preferably, wherein the contact portions that come into contact with an introduced closure have on their surface at least one chuck knurl.

In a third embodiment of the invention the pivoting chuck jaws pivot axially as well as in the horizontal plane so as to allow the pivoting chuck jaws to receive closures that do not have straight sides.

In a fourth embodiment of the invention the contact portion of the chuck jaws that comes into contact with an introduced closure is made of an elastomeric material and is formed into the shape of a wheel that is adapted to turn in order to facilitate the introduction of the closure into the closure zone.

In a fifth embodiment of the invention the non-powered gripping chuck is adapted to operate on radially misaligned closures by providing means to drive the pivoting chuck jaws eccentrically.

Preferably the means to drive the pivoting chuck jaws eccentrically comprises providing the chuck body with a plurality of ribs, that engage slots formed in a drive plate connected to a drive mechanism, and wherein the size of the slots allow the associated chuck body to travel eccentrically around the axis of machine spindle rotation.

Even more preferably in a sixth embodiment of the invention the slots are also adapted to compensate for small backwards movements of the drive plate such that small backwards movements do not translate into backwards movements in the chuck body.

### BRIEF DESCRIPTION OF THE DRAWINGS

FIG. 1 is a perspective view of a first embodiment of the invention;

FIG. 2 is a partial bottom view of a first embodiment of the invention showing jaws and their spacing;

FIG. 3 is a side view of a first embodiment of the invention;

FIG. 4 is a bottom view of a first embodiment of the invention;

FIG. 5 is an exploded view of a first embodiment of the invention;

FIG. 6 is a partial cutaway view of a first embodiment of the invention taken along line A-A of FIG. 4;

FIG. 7 is a further partial cutaway view of a first embodiment of the invention, taken along line B-B of FIG. 4;

FIG. 8 is diagram showing the forces exerted in a first embodiment of the invention;

FIG. 9 is a schematic of the forces and movement of various parts of a first embodiment of the invention;

FIG. 10 is a perspective view of a second embodiment of the invention;

FIG. 11 is a side view of a second embodiment of the invention;

FIG. 12 is a bottom view of a second embodiment of the invention and a method of calculating the maximum number of jaws;

FIG. 13 is a bottom view of a second embodiment of the invention;

FIG. 14 is an exploded view of a second embodiment of the invention;

FIG. 15 is a cutaway side view of a second embodiment of the invention;

FIG. 16 is a diagram showing the forces exerted in a second embodiment of the invention;

FIG. 17 is a schematic of the forces and movements of various parts of a second embodiment of the invention;

FIG. 18 is an exploded view of a third embodiment of the invention;

FIG. 19 is a partial sectional view of a third embodiment of the invention;

FIG. 20 is a further sectional view of a third embodiment of the invention;

FIG. 21 is a perspective view of a fourth embodiment of the invention;

FIG. 22 is a side view of a fourth embodiment of the invention;

FIG. 23 is a bottom plan view of a fourth embodiment of the invention;

FIG. 24 is an exploded view of a fourth embodiment of the invention.

FIG. 25 is an exploded view of a fifth embodiment of the invention.

FIG. 26 is a cross section view of the invention of FIG. 25.

FIG. 27 is a perspective view of the fifth embodiment of the invention in a first configuration.

FIG. 28 is a top plan view of the fifth embodiment of the invention in the first configuration as depicted in FIG. 27.

FIG. 29 is a perspective view of the fifth embodiment of the invention in a second configuration.

FIG. 30 is a top plan view of the fifth embodiment of the invention in the second configuration as depicted in FIG. 29.

FIG. 31 is a top plan view of a sixth embodiment of the invention.

### MODES FOR CARRYING OUT THE INVENTION

The common principle of operation between the six embodiments of the invention described herein is that they are all non-powered chucks with pivoting jaws which are able to adjust to small variations in closure diameters, where the pivoting jaws themselves induce forces or torque (self-energising forces) that vastly improve grip as capping torque is increased. Thus it is now possible to design a chuck that can easily accept a closure and thereafter, provide a grip on the closure surface that increases after the closure has been inserted, much like an expensive, powered capping chuck, but without any of the complications or costs. This overcomes certain problems of the prior art including the problem that some simple non-powered chucks had where they would sometimes damage closures as they had to force the closure into the chuck given the tight fit or high resistance provided by the chuck receiving means. Having a simple non-powered chuck that could receive a closure with an almost loose fit or arrangement and thereafter tighten its grip on the closure would be a significant improvement over the prior art,

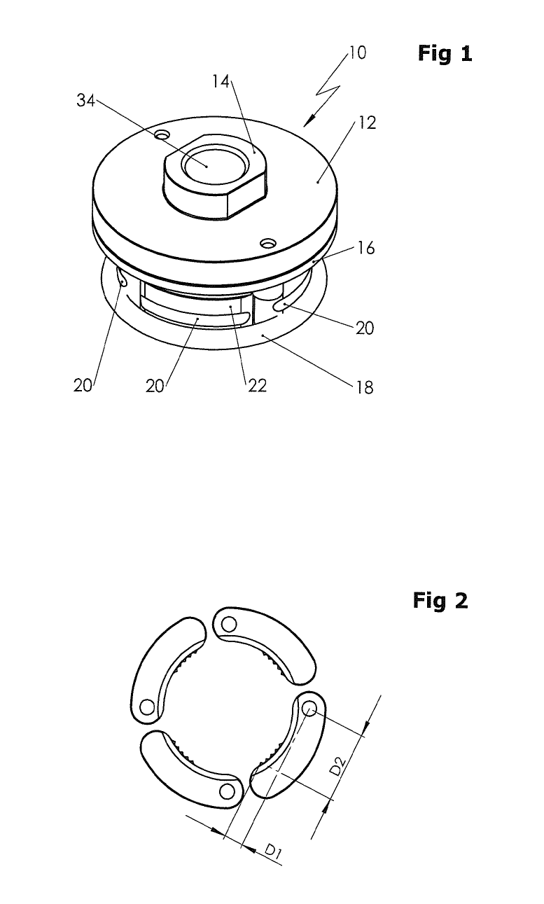

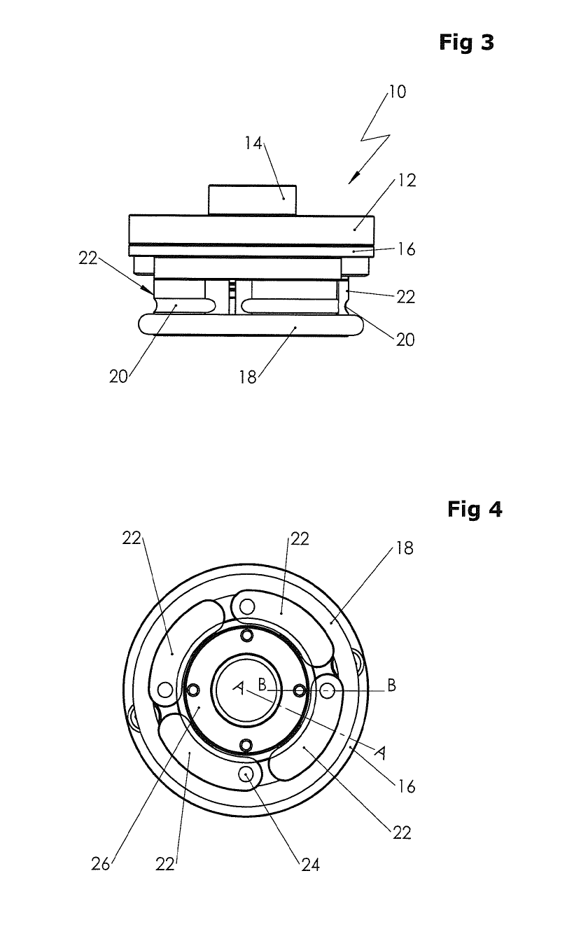

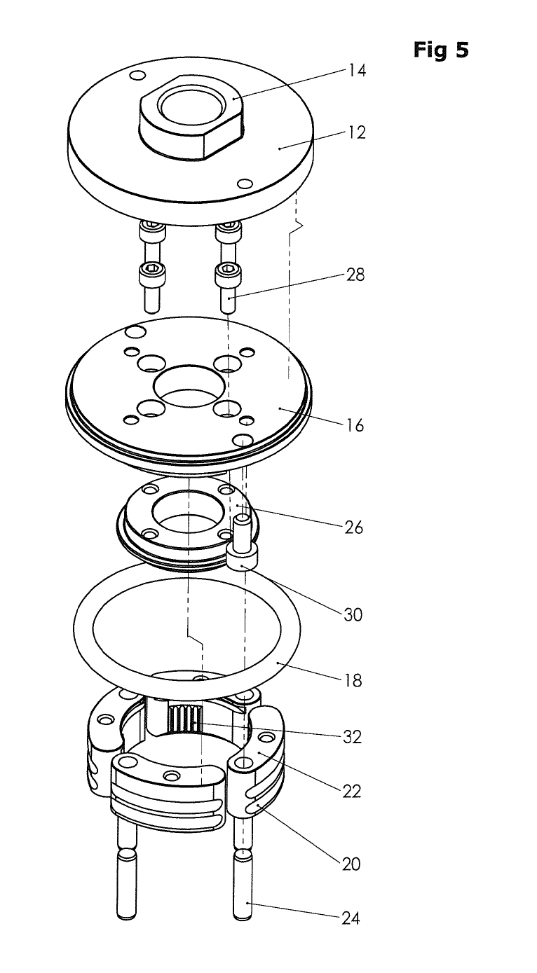

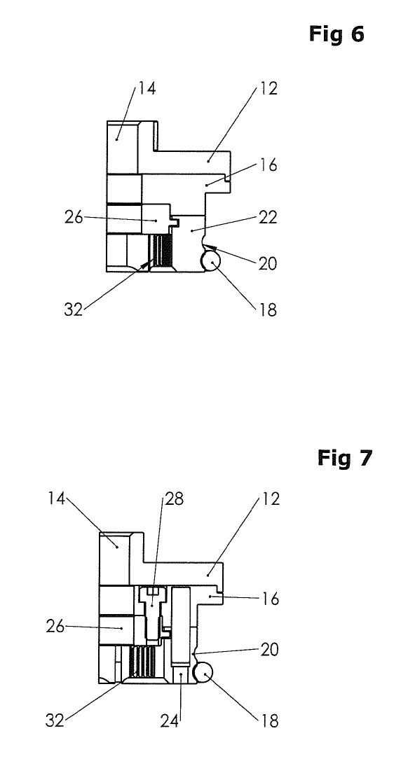

Referring to FIGS. 1 to 9, there is depicted therein, the first embodiment of the invention which incorporates trailing jaws that self energise and grip the knurls of the closure during operation, otherwise known as a trailing jaw chuck 10.

Trailing jaw chuck 10 is comprised of adaptor plate 12 for connecting the chuck to the capping machine by way of a threaded boss 14. Other methods can be used to attach the chuck 10 to the capping machine, as required. Adaptor plate 12 has a central aperture 34 for ejecting the closure by way of a chuck mounted or machine mounted ejector rod (not shown). The chuck body 16 is a disc shaped member with a circumferential rim, that is attached to the adaptor plate 12 by means of screws 30. The chuck body 16 has mounted on it, pivot pins 24. The pivot pins 24, have mounted on them pivotally, chuck jaws 22. There are usually 3 or 4 chuck jaws 22 but there can be more depending on the size of the closure. They are arranged in spaced apart manner around in an annular region proximate the circumferential rim of the chuck body 16 and are adapted to pivot in the horizontal plane where they can swing out so as to increase the available size to accommodate a closure.

Chuck jaws 22 have location grooves 20 for positioning one or more O rings 18. The chuck body also has attached to it, retention plate 26, by means of screws 28. The retention plate 26 holds the chuck jaws 22 apart and against the biasing force supplied by the O ring 18. The chuck jaws 22 have an inwardly facing contact portion which comes into contact with the inserted closure comprising chuck knurls 32. Chuck knurls 32 trail the pivot pins of the chuck jaws 22 in rotation.

In practice the first embodiment which involves a trailing chuck jaw arrangement, operates to close a bottle by way the following steps:

Firstly the O-ring 18 acts as a spring and supplies a biasing force to the chuck jaws 22 which come to rest against the limit ring of the retention plate 26. This results in the knurls being held at their smallest diameter prior to the process of applying the closure. Thereafter the closure is introduced into the cavity. This has the effect of expanding the jaws to accept the closure. The 0 ring 18 is stretched as a result and provides bias to keep the jaws in as tight a radius as possible, and in contact with the closure.

It does not matter in this case whether the knurls align as in this embodiment, if the ridges of the knurl align, the radius or diameter of the chucks jaws is increased so as to receive the closure, and as torque is applied, the knurls become seated and the radius or diameter of the chuck jaws is reduced as a result and the closure is tightened.

The inner limit (diameter) of the retention plate 26 is designed to be slightly smaller than the smallest closure expected to be applied. The outer limit of diameter is not as critical, and is designed to allow for sufficient movement to accept the largest production closure, and to allow for peak to peak clashing of knurls. Also the outer limit diameter is used as a primary assist in centring the closure in the chuck.

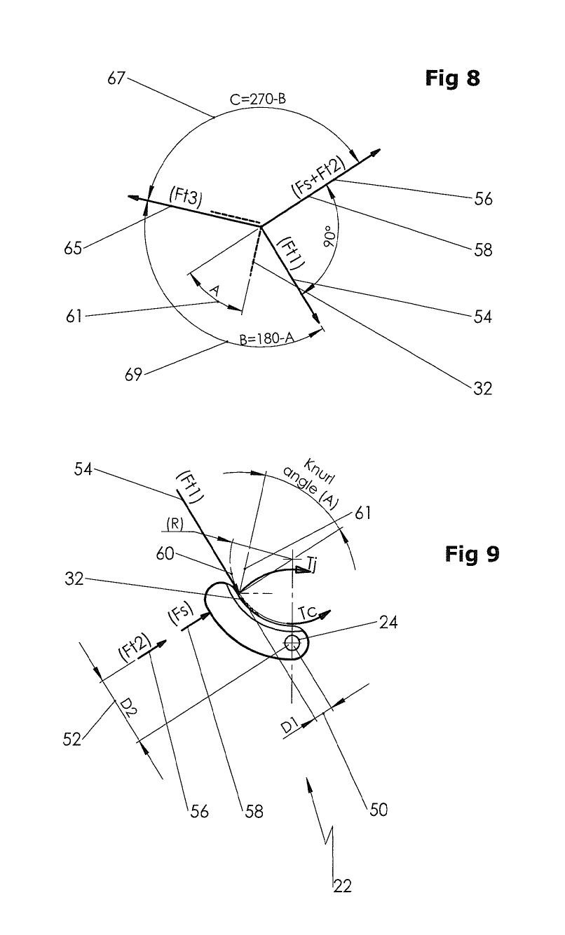

Referring to FIG. 9, the trailing jaw chuck comprising the first embodiment of the invention uses the offset measures D1 50 and D2 52 of the chuck knurls 32 relative to the pivot point of the pivot pins 24 of the chuck jaws 22, and the rotation of the chuck 10, to create a component of induced jaw force Ft2 56 in the area of the chuck knurl 32 that increases available drive torque to the closure. In FIG. 8 Ft2 56 is shown along with Fs 58, Ft1 54 and Ft3 65. In this figure force Ft1 54 exerted by the jaw knurl against the closure knurl, the spring force Fs 58 combined with induced jaw force Ft2 56 acting at 90 degrees to force Ft1 54, and the force Ft3 65 acting at 90 degrees to the jaw knurl thrust surface at angle A 61, act in equilibrium at the jaw knurl. It is Ft1 54 force (the force applied by the jaw knurl 32 to the closure knurl) multiplied by the radius R 60 that represents the individual torque supplied to the knurl of the closure supplied by each jaw. The combination of forces results in a chuck jaw with knurls 32 that are self energised when torque load is applied to them, in that the chuck knurls 32 of the chuck jaws 22 are forced inwards upon rotation by the closure reaction to Ft1 54 which results in good gripping.

Care must be taken not to spin the chuck too quickly as a centrifugal force (not shown)is also generated that may overcome the biasing force of the O-ring 18. This centrifugal force can be compensated for by increasing the spring tension.

In practice the following set of formulas can be used either to design chucks, or modify them to suit the torque requirements of particular closures.

### Formulae and Calculations

### Components of Formulae:

Tc=Required closure driving torque—This is generally known from industry experience. It is the torque required to form an effective closure or seal.

R (60)=Radius of the closure knurl

A (61)=Angle of closure knurl

B (69)=Angle between Ft1 and Ft3

C (67)=Angle between Ft3 and (Fs and Ft2)

Ft0=Combined driving force at knurl contact

Ft1 (54)=Driving force per jaw

Ft2 (56)=induced jaw force (self energising force)

Ft3 (65)=Jaw equilibrium force acting against FT1 and (Fs+Ft2)

n=Number of jaws

D1 (50)=radial offset

D2 (52)=tangential offset

Fs (58)=Required spring force per jaw (Fs)

Tj=Jaw torque—is not the same as Tc and is in fact the torque induced by the offset closure reaction force to Ft1 about pivot point 24 From the known torque Tc and radius R 60, it is possible to calculate Ft0 which is the total force required on all jaws to effect the closure using the following formulas:

$$Tc = Ft 0 \times R$$

$$Ft 0 = \frac{Tc}{R}$$

Ft1, the driving force per jaw can be calculated by taking Ft0 and dividing it by the number of jaws in the chuck (n).

$$Ft 1 = \frac{Ft 0}{n}$$

Once you have calculated Ft1 54 it becomes possible to derive its components, Ft2 56 and Fs 58 by reference to the offset measures D1 50 and D2 52 by using the resultant formulae, and the previously calculated Ft1 54. (where the following relationships apply:

Tj=Ft1×D1, and Tj=Ft2×D2′

and therefore

$$Ft 1 \times D 1 = Ft 2 \times D 2$$

$$Ft 2 = \frac{Ft 1 \times D 1}{D 2}$$

$$Fs = ( \frac{Ft 1 \times Sin B}{Sin C} ) - Ft 2$$

Thus by using a closure of a particular radius and a known required force for closing the closure, and providing a capping chuck of the present invention has D1 50, D2 52 offsets in the chuck jaws 22, it is possible to calculate:

(i) the strength of the spring required to provide the initial biasing of the chuck jaws 22 against the closure, as well as

(ii) the forces induced by the rotation of the chuck as a result of the offsets 50,52.

The following example is provided of a 4 jaw chuck in accordance with the first embodiment of the invention.

TABLE 1
Example of 4 jaw chuck according to a first embodiment of the
invention

| | |
|---|---|
| Required maximum chuck driving torque (Tc) - N-mm | 1130 |
| Contact Radius - (R) - mm | 17.08 |
| Driving force at knurl contact (Ft0) - N | 66.16 |
| Number of jaws (n) | 4 |
| Driving force per jaw (Ft1) - N | 16.54 |
| Pivot radial offset (D1) - mm | 5.27 |
| Pivot tangential offset (D2) - mm | 18.74 |
| Pivot offset ratio (D1/D2) | 0.28 |
| Induced jaw force (Ft2) - N | 4.65 |
| Knurl angle (A) | 45 |
| Angle (B) | 135 |
| Angle (C) | 135 |
| Sin B | 0.707 |
| Sin C | 0.707 |
| Spring force per jaw (Fs) - N | 11.89 |

As can be seen there is a significant difference between the Fs force and the Ft2 force. That is, that the Fs or initial spring biasing force provided by O Ring 18 need only be a portion of the total force that is provided to the closure. That allows a closure to be more easily inserted as it is the Fs 58 force that provides the initial biasing of the chuck jaws 22 against the closure, and thereafter, be tightened properly by virtue of the assistance provided by induced forces Ft2.

Before turning to the second embodiment of the invention it should be noted that the ratios between D1 50 and D2 52 needs to be greater than or equal to 0.25. In Table 1 the ratio was 0.28 which ensures that there will be sufficient induced torque supplied during rotation to significantly reduce the amount of Fs 58 needed.

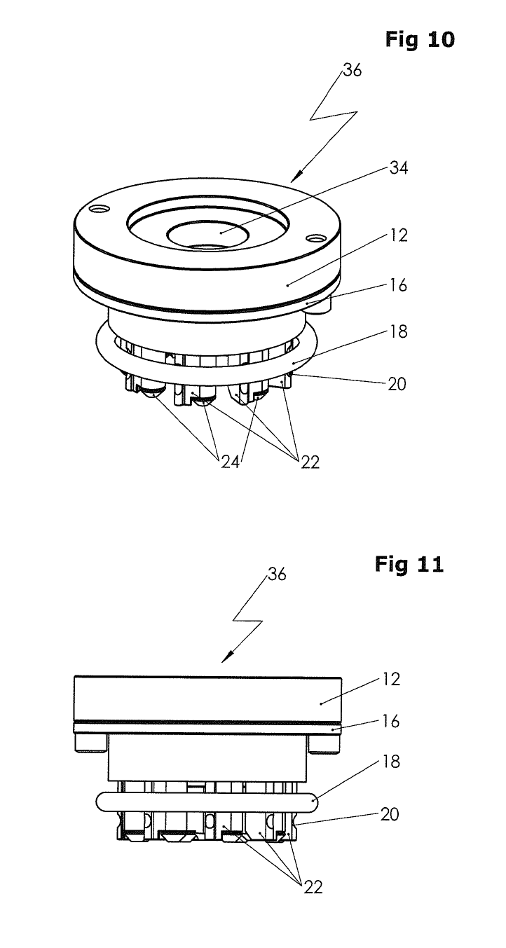

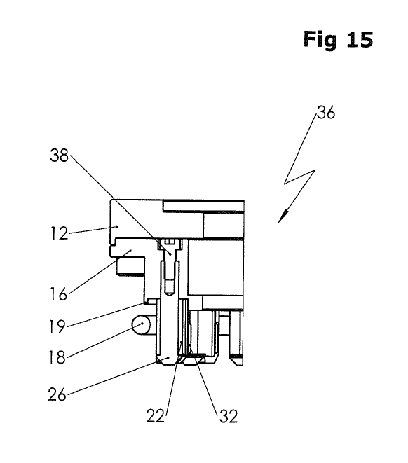

The second embodiment of the invention, a leading jaw chuck 36, is shown in FIGS. 10-17. The leading jaw chuck 36 also uses pivoting chuck jaws 22 that pivot off pivot pins 24, however in this case the chuck knurl 32 (contact portion) is leading and in advance of the pivot pins 24. The pivot pins 24 are held in place, as in the case of the other embodiments, by screws 38 or other securing means. Referring to FIG. 15 wall 19 is provided as a stop to prevent the chuck jaws 22 from over pivoting. Wall 19 prevents therefore the chuck jaws 22 from being secured by the O-ring 18, in the wrong configuration by maintenance personnel when assembling the o-ring tension spring over the jaws. Incorrect assembly of the o-ring tension spring over the knurl edge of the jaws would render the chuck ineffective. The wall 19 is cylindrical in shape and allows the jaws to move about their pivot pins sufficiently to permit the largest of closures to enter the chuck, while preventing the jaws reversing from their working position. The jaws rotate to their minimum diameter working positions when the o-ring spring is assembled.

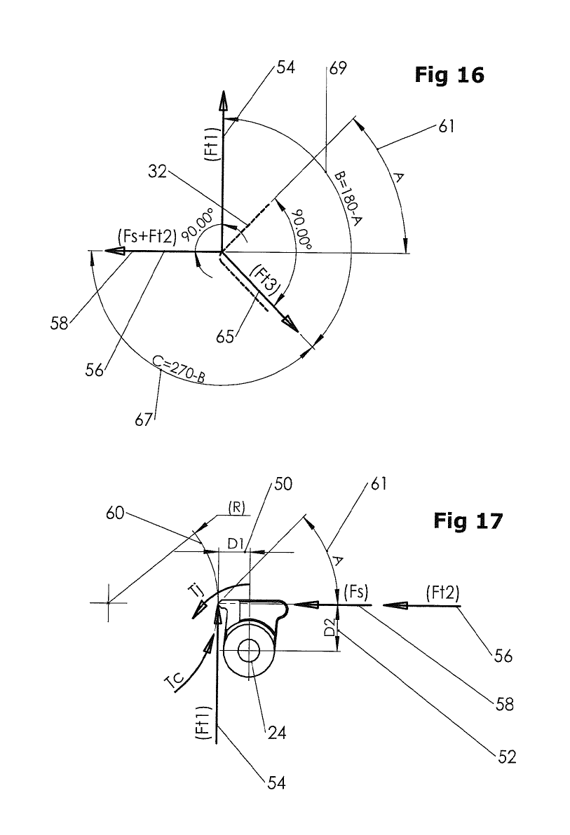

Referring to FIGS. 16 and 17, as the leading jaw chuck 36 rotates, the bias of the O ring 18 (not shown) creates a spring force Fs 58 that biases chuck jaws 22 against an inserted closure (not shown). As a result of Fs 58 and the offsets D1 50 and D2 52, the chuck knurl 32 is biased into the indentations formed in the closure and continues to press into the closure when rotated. This results in a similar, but even greater self energising force than was generated in the first embodiment. That is, this embodiment produces higher induced gripping (self energising) force Ft2 68 than in the case of the first embodiment that utilised trailing chuck jaws 22. This is a result of the ratios of D1/D2 being higher than in the first embodiment, specifically, the ratio needs to be less than 1.2 when used with the most common 90 degree knurl angle.

Turning to the formulae used to determine, Ft2 56 and Fs 58, they are the same as those noted with respect to the first embodiment in that most of the components are the same. Jaw torque Tj is different and derived from the following relationships: (where the following relationships apply:

Tj=Ft1×D1,

and

Tj=Ft2×D2′

and therefore

$$Ft 1 \times D 1 = Ft 2 \times D 2 )$$

$$Ft 2 = \frac{Ft 1 \times D 1}{D 2}$$

$$Fs = ( \frac{Ft 1 \times Sin B}{Sin C} ) - Ft 2$$

The following example in Table 2 is provided of a 4 jaw chuck in accordance with the second embodiment of the invention. The required spring force as compared with the first embodiment in which the same diameter and type closure was used is greatly reduced in the second embodiment (and indeed, third and fourth embodiments which all have leading chuck jaws 22). In Table 1 this value was 11.89 N per jaw. In the second embodiment it is only 5.17N per jaw and the remaining force used to seal the closure comes from the torque Tj of the pivoting chuck jaws 22. Again this allows for a closure to be inserted loosely into the chuck and thereafter for a tight grip be formed around the closure due to the self energising nature of the chuck provided by the pivoting chuck jaws.

TABLE 2
Example of 4 jaw chuck according to a second embodiment of
the invention.

| | |
|---|---|
| Required maximum chuck driving torque (Tc) - N-mm | 1130 |
| Contact Radius - (R) - mm | 17.08 |
| Driving force at knurl contact (Ft0) - N | 66.16 |
| Number of jaws (n) | 4 |
| Driving force per jaw (Ft1) - N | 16.54 |
| Pivot radial offset (D1) - mm | 4.27 |
| Pivot tangential offset (D2) - mm | 6.21 |
| Pivot offset ratio (D1/D2) | 0.69 |
| Induced jaw force (Ft2) - N | 11.37 |
| Knurl angle (A) | 45 |
| Angle (B) | 135 |
| Angle (C) | 135 |
| Sin B | 0.707 |
| Sin C | 0.707 |
| Required spring force per jaw (Fs) - N | 5.17 |

TABLE 3
Example of 10 jaw chuck according to a second embodiment of
the invention

| | |
|---|---|
| Required maximum chuck driving torque (Tc) - N-mm | 1130 |
| Contact Radius - (R) - mm | 17.08 |
| Driving force at knurl contact (Ft0) - N | 66.16 |
| Number of jaws (n) | 10 |
| Driving force per jaw (Ft1) - N | 6.62 |
| Pivot radial offset (D1) - mm | 4.27 |
| Pivot tangential offset (D2) - mm | 6.21 |
| Pivot offset ratio (D1/D2) | 0.69 |
| Induced jaw force (Ft2) - N | 4.55 |
| Knurl angle (A) | 45 |
| Angle (B) | 135 |
| Angle (C) | 135 |
| Sin B | 0.707 |
| Sin C | 0.707 |
| Required spring force per jaw (Fs) - N | 2.07 |

It should be noted that for the example above (second embodiment—leading contact portions) in embodiments 2,3 and 4, 5 and 6—any number of jaws can be included provided that they fit into the chuck body to increase the torque output capability of the chuck. As can be seen in Table 3 above, simply by increasing the number of jaws, the spring force can be reduced even further.

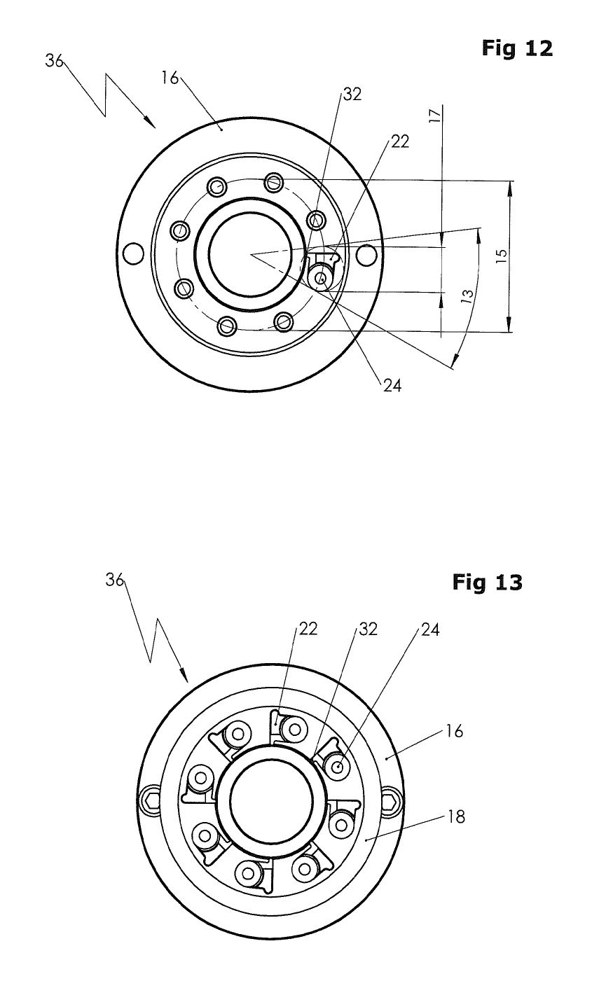

Depicted in FIG. 12 are jaw clearance angle 13, jaw pivot pitch circle 15, and clearance 17. The maximum number of jaws 22 that can be utilised can be calculated by 360 degrees divided by the jaw clearance angle 13.

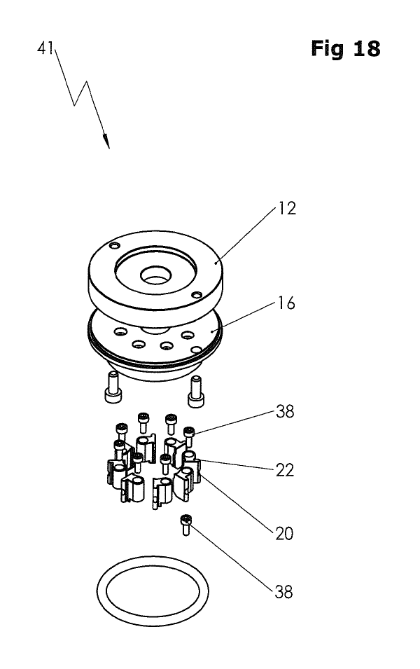

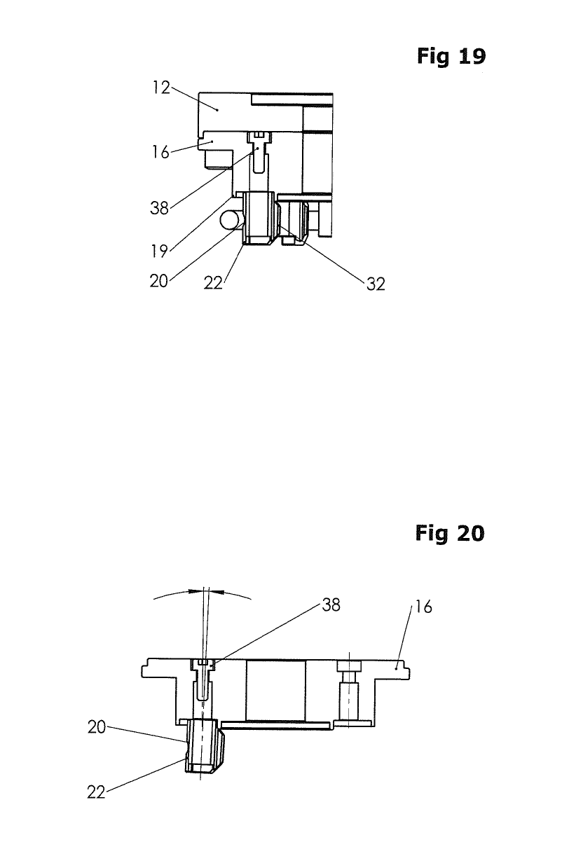

The third embodiment of the invention comprising a leading jaw balanced chuck 41 shown in FIGS. 18 to 20 is essentially a variation of the leading jaw chuck 36. The only substantial difference between this embodiment and the previous embodiment is found in the shape and configuration of the pivot pin 40 which has a concave or bulbous shaped surface in the portion of the pivot pin 40 that comes into contact with the attached leading chuck jaws 22. As a result of the mismatch in surface configurations, the chuck jaws 22 are allowed to pivot about the vertical centre line of the concave or bulbous surface of the pivot pin 40 (the jaw compensation angle 43). This allows the jaws to fit or receive closures that do not have straight walls or are somewhat curved or tapered, and still form an effective mating which allows for a proper seal and more secure grip. In this embodiment the O ring spring 18 is directly in line with the centre of the concave or bulbous portion of the pivot pin 40.

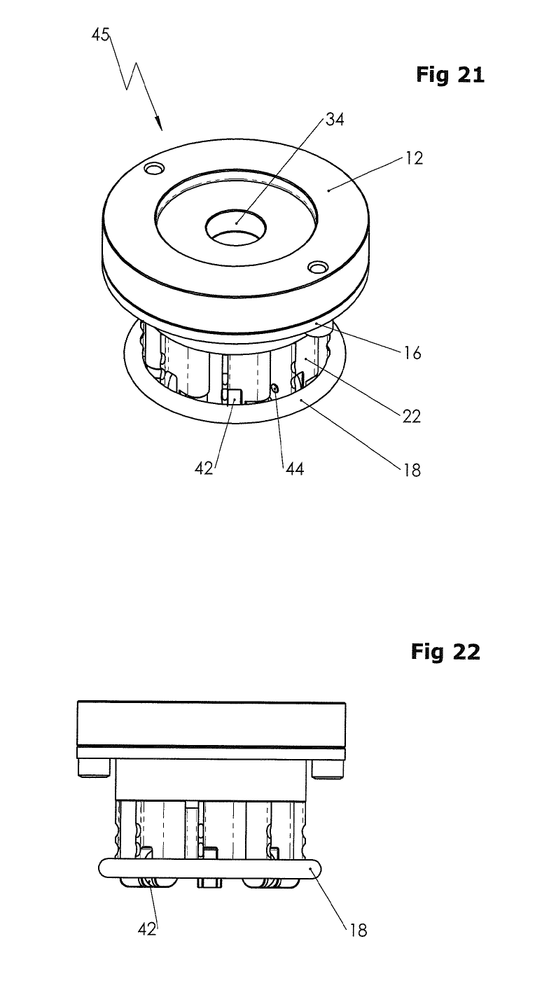

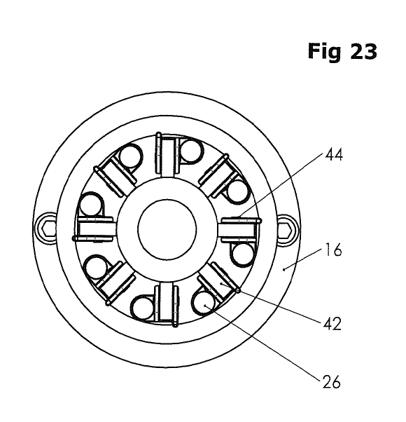

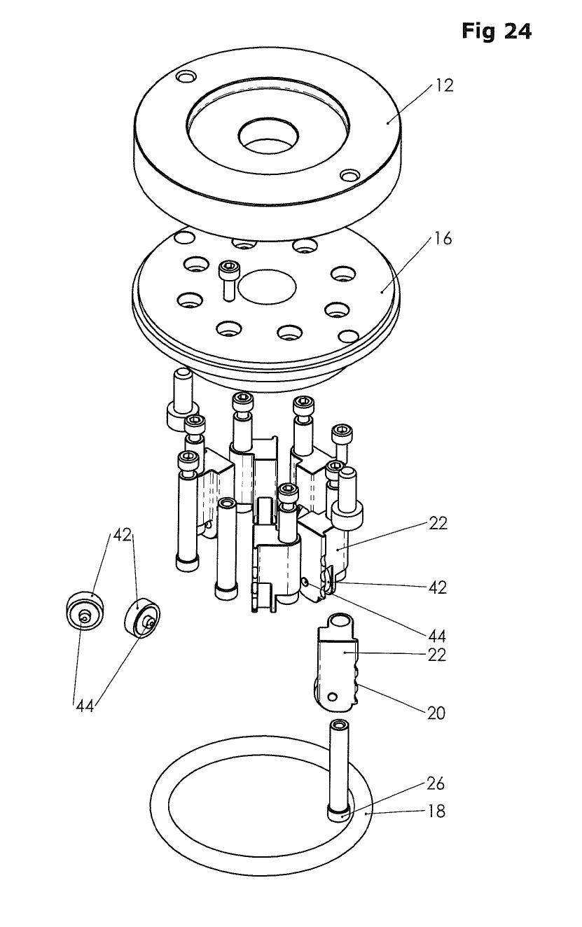

The fourth embodiment disclosed herein is depicted in FIGS. 21-24. The leading jaw roller chuck 45 is again similar in construction to the second and third embodiments, but in this case, chuck jaws 22 posses a roller tyre 42 mounted on a roller wheel 46 by way of an axle pin 44.

The roller tyres 42 enable the closure to roll into place and the displacement of the contact surface of the roller and the pivot point, again result in torque induced increased contact load between the leading edge of the roller tyre 42 surface and the closure surface. The roller in effect replaces the chuck knurl 32. This enables closures with no knurl or closure with projections such as hinges or small visors on lids to be closed using such a chuck (where they would normally be used with a gripping chuck or a tapered rubber cone which tends to damage or break hinges and other surface damage)

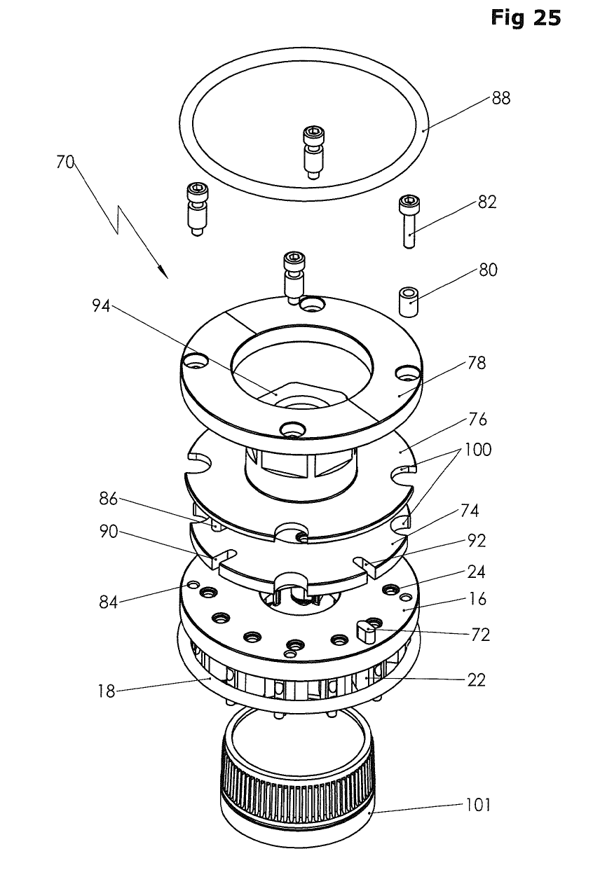

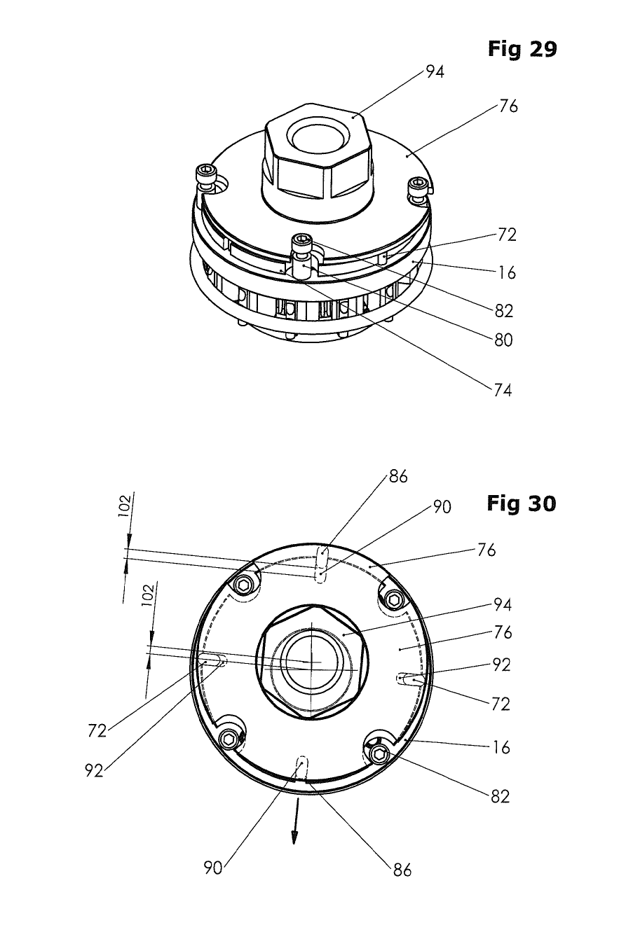

The fifth embodiment of the invention is depicted in FIGS. 25-30, The specific features that exemplify the fifth embodiment are applicable to all of the embodiments of the invention, however it has been depicted in the figures as in the case of the other embodiments, as a modified second embodiment of the invention. The specific features that exemplify the fifth embodiment of the invention include the ability to close closures when the closure is not centred with respect to the centre of machine spindle rotation. Capping chucks with their machine's drive spindles are in practice, often miss-aligned with the closure thread due to machine quality, and poor machine maintenance. Some machines using very strong clamping methods such that they hold the closure rigidly in position and offset from the axis of rotation of the machine's spindle. This causes poorly placed closures, crossed threads, stripped knurls, scrapped product and machine downtime.

According to the fifth embodiment of the invention an eccentric drive mechanism may be built into the chuck to allow concentric alignment of the closure and bottle thread axes during capping where significant miss-alignment between closure and bottle is present. This mechanism will compensate for chuck and closure to bottle neck thread axial miss-alignment by up to 2 mm and more if required.

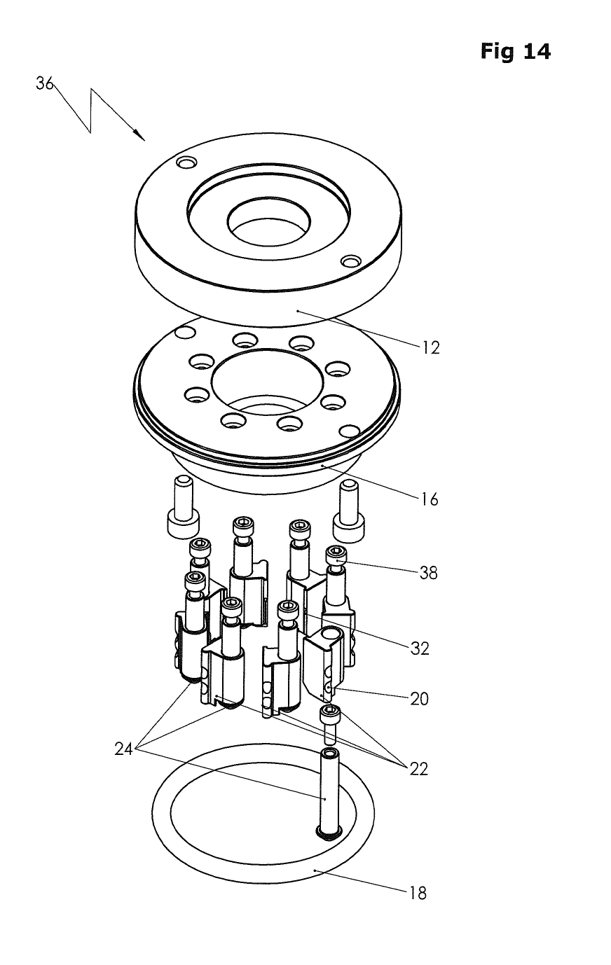

Referring to FIG. 25 there is depicted an exploded view of the components of the capping chuck of the fifth embodiment of the invention, namely the eccentric capping chuck 70. Many of the components depicted are the same as in the case of the third embodiment of the invention namely; chuck body 16, O-ring 18, pivoting chuck jaws 22 that pivot off pivot pins 24. The main difference between this chuck 70 and the chuck 36 of FIG. 14 is that the chuck body 16 is not directly attached or secured to adaptor 12 or any equivalent means of driving the rotation of the chuck body 16.

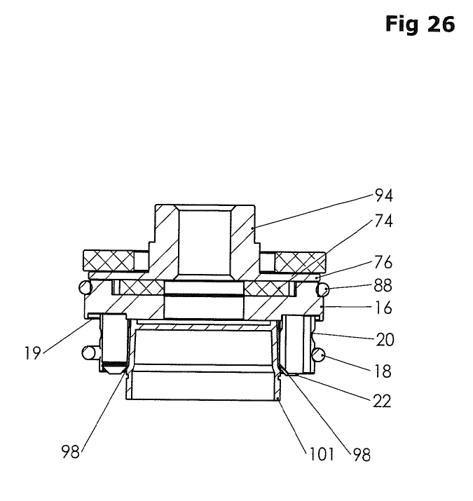

The mechanism consists of 6 main parts a chuck body 16 with drive pegs 72, securing screw holes 84, drive plate 74, an upper alignment plate 76 and cover plate 78. Cover plate is connected to chuck body 16 by way of spacer tubes 80, usually 4 in number, and screws 82 that engage screw holes 84. Spacer tubes 80 and screws 82 are accommodated by way of wide slots 100 located in the upper alignment plate 76 and drive plate 74. The spindle drives the boss 94 on the upper alignment plate 76 as shown in FIG. 26. The upper alignment plate 76 has 2 or more drive pegs 86 projecting from its lower surface. These drive pegs align with slots 90 in the drive plate 74 which have longitudinal clearance of more than 2 mm relative to the drive pegs 86 of the upper alignment plate. That is, the slots 90 have an additional 2 mm in length than the length of the drive pegs 86 such that it allows the drive plate 74 to be displaced in one vertical plane by 2 mm either side of the spindle centreline. The drive plate 74 also has slots 92 at 90 degrees to slots 90. The chuck body 16 has 2 or more drive pegs 72 attached to its upper surface. These drive pegs 72 align with the slots 92 in the drive plate and have longitudinal clearance of more than 2 mm relative to the drive pegs of the chuck body 16.

The slots 92 in the drive plate allow movement of the chuck body 16 by 2 mm in a second vertical plane at 90 degrees (or other angle say 60-90 deg) to the first. The mechanism is lightly centred using an centring o-ring spring 88 to counteract eccentric forces from centrifugal force returning the chuck body 16 to the spindle centre axis after capping is completed.

When the chuck 70 approaches the closure 101, the chuck 70 will be deflected from the spindle centre axis as the lead in chamfer 98 on the jaws contacts the closure. The chuck will then tighten the closure axially at a position offset from the axis of the spindle's rotation while being driven by the machine spindle at its centreline. The combined movement of the upper alignment plate 76, drive plate 74 and chuck body 16 adapts the chuck body 16 to deflect from the axis of rotation of the spindle by 2 mm at any position of spindle rotation.

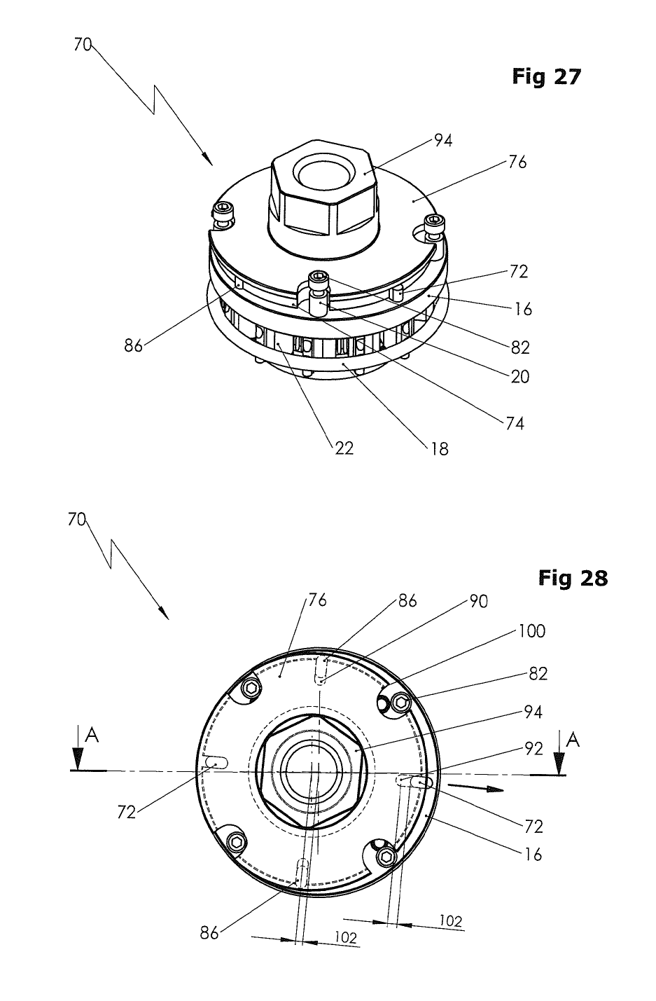

Referring to FIGS. 27-30 there are depicted the chuck 70 depicted in two configurations in which the chuck body centre axis is misaligned with the axis of the shaft 94 by offset 102,

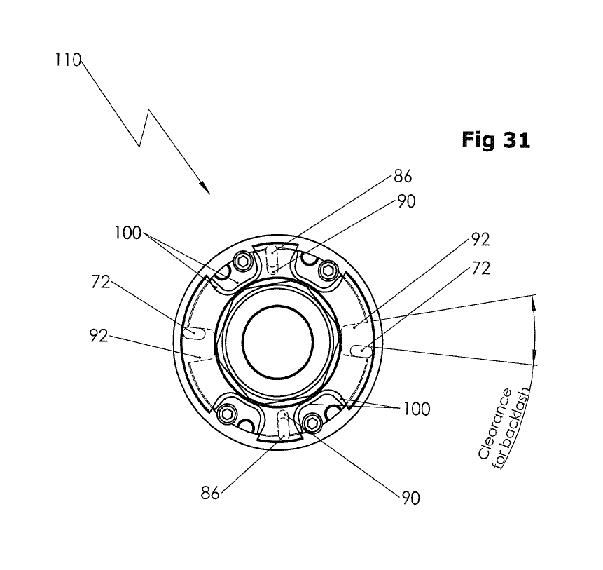

Referring to FIG. 31 is a sixth embodiment of the invention that is the same as the fifth embodiment except for the ability for the chuck 110 to accommodate small backwards movements of the spindle. Most capping machines use magnetic clutches to control the application torque of closures. These are usually permanent magnetic clutches and have 2 main designs. One design provides smooth output torque to the chuck. The second clutch design has multiple permanent magnetic poles often from 12 to 20 poles. The clutch torque is set to trip these poles at a predetermined torque. At the tripping torque the clutch will break away from its magnetic attraction and skip over to the next set of poles. This provides an intermittent drive as the poles of the clutch slip and take up torque. During the slipping process the clutch output shaft attached to the clutch rotor lags the rotation of the clutch body or stator.

As the magnetic poles of the rotor move away from their driving position adjacent to the stator poles and approach the next poles behind, the magnetic attraction of the stator poles behind will drive the rotor backward. This drives the chuck backward and then forward until poles are again aligned with the rotor poles. Repetition of this process causes intermittent torque transfer to the clutch drive output when full torque is exceeded. The behaviour of the chuck of any of the first three embodiments of the invention during the reverse movement of the clutch rotor may ratchet the jaws over the closure knurls repeatedly causing damage to the closure surface. The eccentric mechanism described previously can have free play built into the drive plate. The slots 90 and slots 100 are widened to provide free play of the drive plate allowing the chuck jaws to stay engaged with the closure knurls while the clutch rotor and upper alignment plate drives backwards during the clutch tripping and re-engaging process. Alternatively slots 92 and slots 100 could also, in combination provide the desired degree of movement required to provide the functionality described above. The present invention thereby provides apparatus and method of closing containers using a non-powered or motorised chuck. It will be apparent to persons skilled in the art that various modifications may be made in details of the method described above without departing from the scope or ambit of the present invention.

### INDUSTRIAL APPLICABILITY

The present invention has applicability in the beverage, bottling and container industries that utilise chucks for sealing containers.

1. A non-powered gripping chuck for applying screwed closures comprising a plurality of non-powered pivoting jaws arranged in a circular arrangement on the non-powered gripping chuck defining a capping zone, the non-powered pivoting jaws having a pivot point at their connection with the non-powered gripping chuck and a contact portion that comes into contact with a closure introduced into the capping zone, and tension spring biasing means to bias the plurality of non-powered pivoting jaws against any closure inserted into the capping zone, wherein the contact portion is portions of the plurality of non-powered pivoting jaws are offset from the their respective pivot points such that the non powered pivoting jaws tightly grip against the closure on rotation of the chuck.

2. The non-powered gripping chuck of claim 1 wherein the contact portion trails the pivot point of each of the plurality of non-powered pivoting jaws, during rotation of the chuck and wherein the measure of radial offset and tangential offset between the contact portions and pivot points, when expressed as a ratio, is less than or equal to 0.28.

3. (canceled)

4. The non-powered gripping chuck of claim 1 wherein the contact portion leads the pivot point of the plurality of non-powered pivoting jaws, during rotation of the chuck and wherein the measure of radial offset and tangential offset between the contact portions and pivot points, when expressed as a ratio, is less than or equal to 1.2.

5. (canceled)

6. A non powered gripping chuck for closing closures onto a container comprising:
a chuck body adapted to be rotated wherein the chuck body is circular and has a circumferential rim;
non-powered pivoting chuck jaws attached in a spaced apart manner to an annular region proximate the circumferential rim by way of pivot pins, where the non-powered pivoting chuck jaws define a capping zone into which a closure can be introduced, and wherein the non-powered pivoting chuck jaws have a contact portion that is distal to the pivot pin that comes into contact with an introduced closure; and
tension spring biasing means for biasing the non-powered pivoting chuck jaws against spacing means which maintain an initial minimum diameter for the closure to be inserted;
wherein when a closure is inserted into the capping zone, the contact portions of the pivoting chuck jaws are initially biased against the closure by the tension spring biasing means and wherein during rotation, forces are exerted on the surface of the closure by the contact portion of the pivoting chuck causing the closure to be tightly gripped during the application of the closure.

7. The non-powered chuck jaws of claim 4 wherein the contact portions trail the pivot pins and wherein the measure of radial offset and tangential offset between the contact portions and pivot pins, when expressed as a ratio, is less than or equal to 0.28.

8. The non-powered chuck jaws of claim 7 wherein the contact portions lead in advance of the pivot pins, and wherein the measure of radial offset and tangential offset between the contact portions and pivot pins, when expressed as a ratio, is less than or equal to 1.2.

9. The non-powered chuck jaws of claim 7 wherein the contact portions that come into contact with an introduced closure have on their surface at least one chuck knurl.

10. The non-powered chuck jaws of claim 9 wherein the non-powered pivoting chuck jaws pivot axially at an angle so as to allow them to compensate for closures that do not have straight sides.

11. The non-powered chuck jaws of claim 8 wherein the contact portion of each of the non-powered pivoting chuck jaws that comes into contact with an introduced closure are made of an elastomeric material and is formed into the shape of a wheel that is adapted to turn in order to facilitate the introduction of the closure into the closure zone.

12-14. (canceled)

15. The non-powered chuck jaws of claim 8 wherein the contact portions that come into contact with an introduced closure have on their surface at least one chuck knurl.
